(19) United States
(12) Patent Application Publication
(10) Pub. No.: US 2002/0042721 A1
(43) Pub. Date: Apr. 11, 2002

(54) Network management client

(75) Inventor: Heinz Tillmanns, Stahnsdorf (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/968,918

(22) Filed: Oct. 3, 2001

(30) Foreign Application Priority Data
Oct. 5, 2000 (DE) 100 49 610.5

(51) Int. Cl. G06F 17/60

(52) U.S. Cl. 705/1

(57) ABSTRACT

The invention concerns a network management client, a network management system and a process for supporting the management and monitoring of a communication network. The network management client enables an operator to monitor and manage the communication network by accessing one or more of the network management servers of the network management system, to which a network management area with a set of assigned network elements is assigned. For each of its client applications, at any one time the network management client determines two or more server applications of various network management servers that are assignable to the client application. The network management client then dynamically selects one or more server applications from the server applications assigned to the client application, and initiates a dialogue between the client application and the selected server application or server applications.

### BACKGROUND OF THE INVENTION

The invention is based on priority application DE 100 49 610.5 which is hereby incorporated by reference.

The invention concerns a network management client for the management and monitoring of a communication network by an operator, a network management system for the management and monitoring of a communication network by one or more operators, and a process for supporting the management and monitoring of a communication network by an operator of the communication network.

The invention is based on the following known solutions for implementing network management functions in a telephone network.

The network management system consists of a number of network management servers and network management clients. Each of the network management servers is assigned to a network management area and connected to the switching centres of this network management area. The network management servers carry out network management functions for the switching centres of the network management area and thus control these switching centres. Regarding the execution of network management functions, the switching centres of a network management area communicate exclusively with the network management server assigned to this network management area.

The personnel of the operator of the telephone network control and monitor the telephone network by means of the network management clients. At each network management server is at least one network management client that is exclusively assigned to this network management server, by means of which network management client an operator monitors and controls the network management area. For this, the network management client has access to the network management server assigned to it, that is to say, the client applications of the network management client access permanently assigned server applications of the assigned network management server. It is also possible in this case for an operator, via special control commands, to arrange the assignment of a network management client to another network management area and therefore the assignment to another network management server.

### SUMMARY OF THE INVENTION

The object of the invention is now to improve the management and monitoring of a communication network by a network management system.

1. This object is achieved by a network management client for the management and monitoring of a communication network by an operator, wherein the network management client is designed so that it enables the operator to monitor and manage the communication network by accessing one or more network management servers, each of which is assigned a network management area with a set of assigned network elements, the network management client containing at least one client application, which, in order to carry out a function for the monitoring or control of the communication network by the operator, has access to a server application of one of the network management servers which offers to client applications of network management clients the implementation of network management services in relation to the network elements of the network management area that is assigned to its network management server, the network management client is designed so that it determines for the client application two or more server applications of various network management servers, which are assignable to the client application, and that the network management client is further designed so that it dynamically selects one or more server applications from the server applications assignable to the client application, and initiates a dialogue between the client application and the selected server application or server applications.

This object is achieved by a network management system for the management and monitoring of a communication network Network management system for the management and monitoring of a communication network by one or more operators, with two or more network management servers, each of which is assigned a network management area with a set of assigned network elements, and with at least one network management client, that is designed so that it enables the operator to monitor and manage the communication network by accessing one or more network management servers, wherein the network management client containing at least one client application for carrying out a function for the monitoring or control of the communication network by the operator, and each of the network management servers containing at least one of the server applications, which offer client applications of network management clients the implementation of network management services in relation to the network elements of their network management area, wherein the network management client is designed so that it determines for the client application two or more server applications of various network management servers, assignable to the client application, and that the network management client is further designed so that it dynamically selects one or more server applications from the server applications assignable to the client application, and initiates a dialogue between the client application and the selected server application or server applications.

This object is achieved by a process for supporting the management and monitoring of a communication network Process for supporting the management and monitoring of a communication network by an operator of the communication network, wherein a network management client enables the operator to monitor and manage the communication network by accessing one or more network management servers, each of which is assigned a network management area with a set of assigned network elements, for carrying out a function for the monitoring or control of the communication network by the operator, at least one client application of the network management client has access to a server application of one of the network management servers, which offers client applications of network management clients the implementation of network management services in relation to the network elements of the network management area that is assigned to its network management server, the network management client determines for the client application two or more server applications of various network management servers, which are assignable to the client application, that the network management client dynamically selects one or more server applications from the server applications assignable to the client application, and initiates a dialogue between the client application and the selected server application or server applications.

The invention is based on the idea of breaking the usual 1:1 relationship between client application and assigned server application and replacing it by a dynamically varying 1:n relationship between client application and server applications of different network management servers. In this case the development of this “multi-server access” is not computer-specific but application-specific. The “multi-server access” can be individually used by each client application without affecting the remaining applications. To do this, those two or more server applications of different network management servers, that can be assigned to the client application, are determined by a network management client for one client application. The network management client then dynamically selects one or more server applications from this number of assignable server applications, and initiates a dialogue between the client application and the selected server application or server applications.

The advantage for the user of a client application lies in the fact that the selection and connection to the necessary servers is carried out transparently and automatically. For the client application it remains transparent whether it is connected to one or to several server applications.

The communication connections between client applications and server applications are set up and cleared down again automatically as required. Manual selection of a network management server by the operator is not necessary.

There is no separation according to network management servers in the display of the client application, the received data of the server applications are displayed in standard lists, tables, etc., so that the network management server which has supplied them remains concealed.

A further advantage is that communication connections between network management clients and servers are only set up when required and no unused connections are maintained.

Advantageous developments of the invention are revealed in the sub-claims.

### BRIEF DESCRIPTION OF THE DRAWINGS

The invention is explained by way of example below by means of several exemplary embodiments with the aid of the accompanying drawings, in which:

FIG. 1 shows a block diagram of a communication network with a network management system according to the invention.

FIG. 2 shows a functional representation of a section of the network management system of FIG. 1.

### DETAILED DESCRIPTION

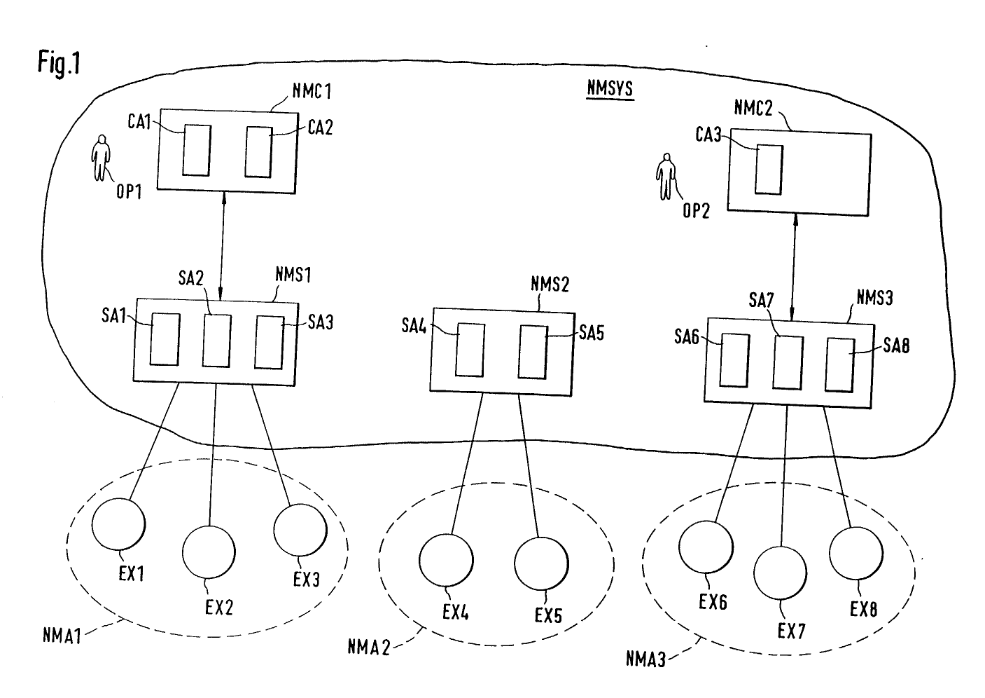

FIG. 1 shows several network elements EX1 to EX8 of a communication network, as well as a network management system NMSYS for the management and monitoring of the communication network by operators OP1 and OP2. The network management system NMSYS has several network management servers NMS1 to NMS3 and several network management clients NMC1 and NMC2. The network elements EX1 to EX3 are assigned to a network management area NMA1, the network elements EX4 and EX5 are assigned to a network management area NMA2 and the network elements EX6 to EX8 are assigned to a network management area NMA3. The number of network elements per network management area and the number of network management servers and network management clients is chosen by way of example.

Each of the network elements EX1 to EX8 is formed by a switching centre. However, it is also possible for the network elements EX1 to EX8 to be other types of network elements, for example routers, bridges, cross-connects or a mixture of various types of network elements. Advantageously, the assignment of network elements to the network management areas NMA1 to NMA3 is implemented according to spatial criteria.

Each of the network management servers NMS1 to NMS3 and the network management clients NMC1 and NMC2 is formed by a computer or several interconnected computers, on which runs a software platform, comprising for example an operating system and a database system and one or more application programs, which control the operation of the network management servers NMS1 to NMS3 and the network management clients NMC1 and NMC2.

The network management clients NMC1 and NMC2 enable the operators OP1 and OP2, respectively, to monitor and manage the communication network by accessing one or more of the network management servers NMS1 to NMS3. To do this, each of the network management clients NMC1 and NMC2 has several client applications, of which two client applications CA1 and CA2 for the network management client NMC1 and one client application CA3 for the network management client NMC2, are shown as examples in FIG. 1.

The client applications CA1 to CA3 provide each of the operators OP1 and OP2, respectively, with a special function for carrying out the monitoring and/or control of the communication network by the respective operator OP1 or OP2. The client applications CA1 and CA3 provide the No. 7 management function, for example, and the client application CA2 provides the faults and messages display function. Examples of further functions for implementing the monitoring and control of the communication network by the respective operator are: processing of equipment faults and faulty connections, processing of capacity utilisation and settings data of network elements, as well as their interconnection in the network, processing of the parameters relevant to call billing, processing of quality data, processing related to security and safety.

Each of the client applications CA1 to CA3 is formed by one or more application programs, which run on the software platform of the network management clients NMC1 and NMC2. Client applications, and thus the application programs assigned to them, are started by the network operators OP1 and OP2 on the network management servers NMC1 or NMC2, respectively, if the special function supplied by the respective client application is required by the operators.

In this case it is also possible for access to the separate client applications CA1 to CA3 to be individually restricted and that during access or on starting the client applications CA1 to CA3, the network operators OP1 and OP2 have to identify themselves for authorisation to be checked.

A network management area NMA1, NMA2, and NMA3, respectively, with a set of assigned network elements EX1 to EX3, EX4 and EX5, and EX6 to EX8, respectively, is assigned at any one time to the network management servers NMS1 to NMS3. The network management servers NMS1 to NMS3 communicate with the network elements of their network management area by means of a network management protocol, for example by means of the CMIP (Common Management Information Protocol) or SNMP (Simple Network Management Protocol). By means of this communication they send control messages to these network elements and receive status and fault messages from these network elements.

The transmission of control messages to the network elements of the respective network management area and the receipt and processing of status and fault messages from these network elements is controlled within the network management servers NMS1 to NMS3 by server applications, of which three server applications SA1 to SA3 of the network management server NMS1, two server applications SA4 and SA5 of the network management server NMS2 and three server applications SA6 to SA8 of the network management server NMS3 are shown by way of example in FIG. 1. The server applications SA1 to SA8 offer client applications of network management clients the provision of network management services in relation to the network elements of their respective network management area. Via access to these services, the client applications CA1 to CA2 supply their respective function to the network operators OP1 and OP2, respectively. Client applications of the network management clients NMC1 and NMC2 therefore interact within respective client-server relationships with server applications of the network management servers NMS1 to NMS3. In each case the server applications SA1 to SA8 are here formed by one or more application programs which run on the software platform of the network management servers NMS1 to NMS3.

The network management clients NMC1 and NMC2 thus allow the operators OP1 and OP2, respectively, to monitor and manage the communication network by accessing one or more of the network management servers NMS1 to NMS3. In order to carry out their special function for the monitoring or control of the communication network by the operators, in this case the client applications of the network management clients have access to at least one server application of one of the network management servers NMS1 to NMS3. For each of their client applications, the network management clients NMC1 and NMC2 determine two or more server applications of various network management servers, which can be assigned to the client application. Subsequently, the network management clients NMC1 and NMC2 dynamically select one or more server applications from the respective server applications assignable to a client application, and initiate a dialogue between the client application and the selected server application or server applications.

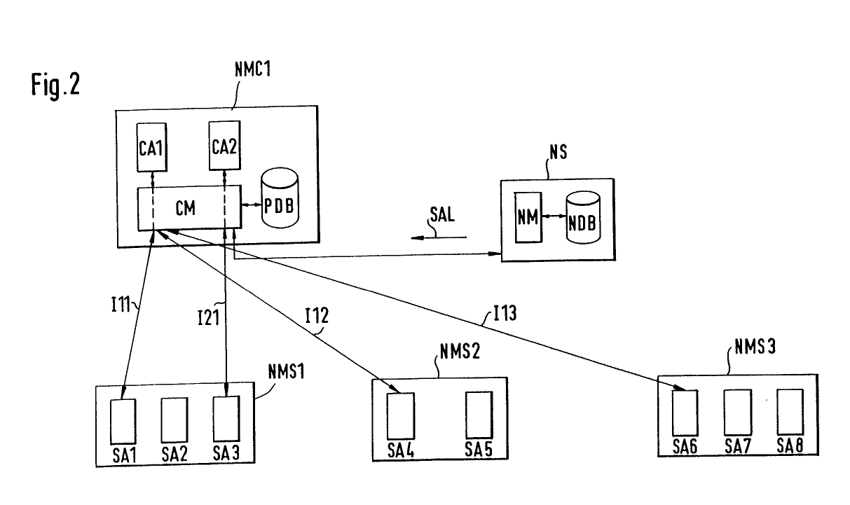

The detailed mode of operation of the network management clients NMC1 and NMC2 is explained by way of example in FIG. 2 by the mode of operation of the network management client NMC1.

FIG. 2 shows the network management client NMC1 with the client applications CA1 and CA2, the network management servers NMS1 to NMS3 with the server applications SA1 to SA8, and a server NS. The server NS represents a designating server central to several network management clients, which provides these network management clients with data relating to the server applications available in the communication network. It is also possible to dispense with the server NS.

The server NS is formed by one or more interconnected computers on which are run a software platform, application programs and data, which provide the functions of the server NS described in the following. However, it is also possible for the server NS to be a virtual server and be comprised of only these application programs and data. These application programs can then run on the system platform of one of the network management clients or network management servers of the network management system NMSYS for example.

From a functional point of view, the server NS has a functional module NM and a database NDB. The identification codes and/or the names of the active server applications of the network management system NMSYS, as well as an assigned address, via which the respective server application can be contacted, are stored in the database NDB. Moreover, it is possible for additional parameters which contain further information about the properties of the respective server application, to be assigned to a server application. It is also possible that, in addition to the active server applications, all inactive server applications of the network management system NMSYS are listed in the database NDB. The functional module NM allows network management clients of the network management system NMSYS access to the data of the database NDB.

From a functional point of view, the network management client NMC1 has, in addition to the client applications CA1 and CA2, a functional module CM and a database PDB.

Assignments are stored in the database PDB, which assigns to each of the client applications CA1 and CA2 two or more of the server applications of different network management servers that are assignable to the respective client application. For example, for each of the client applications CA1 and CA2, the database PDB therefore stores a profile with a list in which the identification codes of the assignable server applications are stored. This identification code consists, for example, of a name, an object name, a network address or an object address of this server application. Furthermore, it is advantageous if the profile assigns to each of the identification codes one or more parameters which contain further information about the respective server application.

The functional module CM is formed from one or more of the application programs which run on the software platform of the network management server NMC1, and which, when processed, carry out the functions described below.

The functional module CM allows transparent communication between the client applications CA1 and CA2 and the server applications of the network management servers of the network management system NMSYS. For this, the functional module CM provides the client applications CA1 and CA2 with a service, by which these client applications communicate with appropriate server applications. The functional module CM therefore fulfils the role of a “communication manager” for the communication between the client applications of the network management client NMC1 and server applications of the network management servers of the network management system NMSYS. In this case the client applications specify the properties of a server application vis-a-vis the functional module CM, from which they would like to take a service, for example by requesting a specific network management service with specific parameters. The functional module CM identifies one or more suitable server applications and initiates—transparently for the client application—the dialogue between the client application and these server applications.

First of all the functional module CM determines for the client applications CA1 and CA2 two or more of the server applications of various network management servers, which are assignable to the respective client application. This determination takes place preferably at a time when the respective client application is started. But it is also possible for this determination to take place during the initialisation of the network management server NMC1, or at the first request by the client application for a dialogue with a server application.

The server applications assignable to a client application preferably represent those server applications which offer at least one network management service that can be used for the client application. In this respect, it is also possible for the group of server applications assignable to a client application to be made narrower or wider. It can, for example, include only those server applications that offer all the network management services required by the client application, but also include those server applications that offer a service usable for the client application only under very special conditions. The server applications assignable to a client application can also be those server applications that are able to fulfil at least one function intended for the client application. Advantageously, the assignable server applications include server applications from different network management servers, if possible all of the network management servers of the network management system NMSYS. As a result, the client application is able to provide the network management function for the entire area of the network management system NMSYS.

It is possible for the functional module CM to determine the server applications assignable to a client application by access to a list of the network management services offered to the server applications of the network management system. Such a list can be held locally; access to this list via the central server NS is also useful: for example the database NDB lists which network management services offer the server applications of the network management system, and assignable server applications are then determined by means of these data.

It is also possible for the client applications and server applications of the network management system to be assigned to different groups of client or server applications according to the functions provided by them. Membership of such a group can be reflected in the name of the client applications and/or server applications, for example. All applications of one such group can have the same name, for example. From a functional point of view, one or more groups of server applications can be assigned to one group of client applications. For example, that group of server applications that offers services for these client applications can be assigned to a group of client applications. This client application group to server application group assignment can be stored in the network management server NMC1 or in the server NS.

For the determination of the server applications assignable to the client application CA1, that group of client applications that is assigned to the client application CA1, is determined in a first step. The group(s) of server applications assigned to the specific group of client applications is (are) then determined by means of the assignment. Those server applications of the network management system NMSYS that are assigned to the specific group(s) of server applications are then determined. Advantageously, this is realised by access to the server NS.

A request with an identification of the specific group(s) of server applications is sent to the server NS. This can consist, for example, of the name of one or more server applications (all server applications of a group of server applications have the same name). By accessing the database NDB, the functional module NM determines the assigned server applications of the network management system NMSYS. A list SAL with the addresses, possibly also the identification codes of the determined server applications, is then downloaded to the network management client NMC1 and assigned to the client application in the database PDB.

In a second step, the server applications determined for the client application are contacted in succession by the functional module CM in order to ascertain under what conditions these server applications offer services. It is also possible for the functional module CM to contact the server applications determined for the client application, in order to ascertain which of these server applications provides which services under what conditions. In this case it is advantageous if this determination is tailored to the special requirements of the client application and therefore relevant data are determined only for the selection of a server application for this special client application. In this way, for example, those server applications which can provide a specific function or a specific service for the client application are specified on the various network management servers of the network management system.

By contacting the determined server applications, a profile of the server applications determined for the client application is established and stored in the database NDB.

It is also possible to dispense with the second step. In this case it is advantageous, when a service of a server application is requested by a client application, to contact the assigned server applications in succession as described above, until one or more server applications which meet the current requirements of the requesting client application are identified. One such method can consist of a trial and error procedure in which a succession of tests is run to see which of the server applications best meets the requirements of a special request from the client application. These results can also be stored in a profile of the client application in the database NDB. By repeating this method, if the data existing in the profile are inadequate or incorrect, the profile of the client application can be dynamically updated.

It is also possible in this way to create a central profile for a group of client applications and store it in the database NDB. It is further possible to create a central profile for server applications and dynamically update it when contacting the determined server applications.

Moreover, the functional module CM dynamically selects one or more server applications from the server applications assignable to the client application and initiates a dialogue between the client application and the selected server application or server applications. Each time a client application sends a request to a server application, the functional module CM dynamically selects one or more server applications from the assigned server applications that are already stored in the database NDB. It then initiates the forwarding of the request to the selected server application(s).

The functional module CM makes the selection dynamically, that is to say there is no fixed assignment of client and server applications; this assignment is always re-specified according to the circumstances and is automatically adapted to a change in circumstances. Furthermore, the functional module CM makes the selection by means of data concerning the context and the content of the request, as well as by means of data related to the assigned server applications. For this, the functional module CM advantageously uses the profile of the requesting client application stored in the database PDB. If such a profile is not present or does not contain the necessary data, it is also possible, as already explained above, for the functional module CM to contact one or more of the assigned server applications. In this respect, it is also possible to dynamically update the profile of the client application during this contact. Access to a central server application profile in order to determine this data is also possible.

By means of this data, the functional module CM selects that server application or those server applications to which the request is directed in order to achieve the purpose associated with the request. Criteria to be taken into consideration here are, for example, the requested network management service, the client application's rights of access to the various server applications and network management servers, affected network elements or groups of network elements. To achieve this purpose, it can sometimes be necessary to send the request in parallel to several server applications, for example if network elements from different network management areas are involved. cm 2. Network management client for the management and monitoring of a communication network by an operator, wherein the network management client is designed so that it enables the operator to monitor and manage the communication network by accessing one or more network management servers, each of which is assigned a network management area with a set of assigned network elements, the network management client containing at least one client application, which, in order to carry out a function for the monitoring or control of the communication network by the operator, has access to a server application of one of the network management servers which offers to client applications of network management clients the implementation of network management services in relation to the network elements of the network management area that is assigned to its network management server, the network management client is designed so that it determines for the client application two or more server applications of various network management servers, which are assignable to the client application, and that the network management client is further designed so that it dynamically selects one or more server applications from the server applications assignable to the client application, and initiates a dialogue between the client application and the selected server application or server applications.

2. Network management client according to claim 1, wherein the network management client is further designed so that for the determination of the two or more assignable server applications, it determines those server applications of the network management server of a network management system, which offer network management services usable for the client application.

3. Network management client according to claim 1, wherein the network management client is further designed so that for the determination of the two or more assignable server applications, it has access to a server that is central to several network management clients.

4. Network management client according to claim 3, wherein the network management client is further designed so that it downloads from the central server a list with the addresses of the determined server application and assigns it to the client application.

5. Network management client according to claim 1, wherein the network management client is further designed so that it contacts the server applications determined for the client application, in order to determine under what conditions these server applications provide services.

6. Network management client according to claim 1, wherein the network management client is further designed so that it contacts the server applications determined for the client application, in order to determine which of these server applications provides which services and under what conditions.

7. Network management client according to claim 1, wherein the network management client is further designed so that by contacting the determined server applications, it creates a profile of the server applications determined for the client application, and uses this profile for the dynamic selection of one or more server applications.

8. Network management client according to claim 1, wherein the network management client is further designed so that it dynamically updates the profile of the server applications determined for the client application when contacting the determined server applications.

9. Network management system for the management and monitoring of a communication network by one or more operators, with two or more network management servers, each of which is assigned a network management area with a set of assigned network elements, and with at least one network management client, that is designed so that it enables the operator to monitor and manage the communication network by accessing one or more network management servers, wherein the network management client containing at least one client application for carrying out a function for the monitoring or control of the communication network by the operator, and each of the network management servers containing at least one of the server applications, which offer client applications of network management clients the implementation of network management services in relation to the network elements of their network management area, wherein the network management client is designed so that it determines for the client application two or more server applications of various network management servers, assignable to the client application, and that the network management client is further designed so that it dynamically selects one or more server applications from the server applications assignable to the client application, and initiates a dialogue between the client application and the selected server application or server applications.

10. Network management system according to claim 9, wherein the network management system is further designed so that it is provided with a designating server central to several network management clients, that is designed so that it provides network management clients with information about the server application available in the communication network.

11. Process for supporting the management and monitoring of a communication network by an operator of the communication network, wherein a network management client enables the operator to monitor and manage the communication network by accessing one or more network management servers, each of which is assigned a network management area with a set of assigned network elements, for carrying out a function for the monitoring or control of the communication network by the operator, at least one client application of the network management client has access to a server application of one of the network management servers, which offers client applications of network management clients the implementation of network management services in relation to the network elements of the network management area that is assigned to its network management server, the network management client determines for the client application two or more server applications of various network management servers, which are assignable to the client application, that the network management client dynamically selects one or more server applications from the server applications assignable to the client application, and initiates a dialogue between the client application and the selected server application or server applications.
